(19) United States
(12) Patent Application Publication
(10) Pub. No.: US 2005/0279130 A1
(43) Pub. Date: Dec. 22, 2005

(54) 18O[O2] oxygen refilling technique for the production of 18[F2] fluorine

(75) Inventor: Helen Bjork, Uppsala (SE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: General Electric Company

(21) Appl. No.: 10/869,911

(22) Filed: Jun. 18, 2004

(51) Int. Cl. B01D 47/00; F17C 9/02; F25J 1/00

(52) U.S. Cl. 62/606; 62/50.2

(57) ABSTRACT

The present invention is a controlled high-purity apparatus and method for transporting a well defined gas volume from a larger gas volume with high pressure into a smaller volume by cryogenic cooling. Particularly, a refilling apparatus includes a first fluid container, a second fluid container, and an interface for coupling the first and second fluid containers to a supply of gas. The first fluid container has a volume corresponding to a certain amount of liquid condensed from the gas, which upon phase transformation provides a desired gas pressure within the total volume of the first and second fluid containers. The first fluid container is preferably a coil of tubing for submersion into a bath of liquid nitrogen to cryogenically cool the first fluid container, thereby condensing the gas into liquid form. The invention is particularly well-suited for providing [¹⁸O]oxygen gas to a [¹⁸O]O₂/F₂ target system producing [¹⁸F]fluorine gas. The desired pressure is ideally 40 to 50 bar in order to supply the [¹⁸O]O₂/F₂ target system with an appropriate amount of [¹⁸O]oxygen gas for a commercially significant number of production runs between refills of the refilling apparatus.

### BACKGROUND OF THE INVENTION

1. Field of Invention

This invention generally relates to production of radionuclides, particularly a technique for refilling [¹⁸O]oxygen in a system for producing [¹⁸F]fluorine gas.

2. Description of Related Art

Positron emission tomography (PET) is a medical imaging technique for measuring the concentrations of positron-emitting radiopharmaceuticals within the tissue of living subjects. Radiopharmaceuticals prepared from cyclotron-produced fluorine-18 radionuclide have found widespread use in a variety of PET biological probes for research and clinical investigations of the brain, heart, and in the diagnosis of cancer. In a typical PET procedure, the radiopharmaceutical is administered to the bloodstream of a subject and the distribution of positron activity emitted from the radiopharmaceutical in vivo is then measured by emission tomography as a function of time. A computerized reconstruction procedure is implemented to produce tomographic images of the tissue as it interacts with the radiopharmaceutical.

Synthesis of fluorine-18 in the form of [¹⁸F]fluorine gas is a significant step in PET studies. Because the half-life of fluorine-18 is approximately 109.8 minutes, PET operators prefer to have a fluorine-18 producing cyclotron on-site so as to avoid losing a significant fraction of the produced isotope during transportation.

Conventional production of [¹⁸F]fluorine gas typically employs a “two-shot” process using a cyclotron generated proton beam and a target containing ¹⁸O₂. See, e.g., R. J. Nickles et al., An ¹⁸O₂ Target for the Production of [¹⁸F]F₂, Int. J. Appl. Radiat. Isot., Vol. 35, No. 2, 117-122 (1984); A. Bishop et al., Proton Irradiation of [¹⁸O]O₂: Production of [¹⁸F]F₂ and [¹⁸F]F₂+[¹⁸F]OF₂, Nuclear Medicine & Biology, Vol. 23, 189-199 (1996); and A. D. Roberts et al., Development of An Improved Target for [¹⁸F]F₂ Production, Appl. Radiat. Isot., Vol. 46, No. 2, 87-91 (1995), the disclosures of which are incorporated herein by reference in their entirety. In a “two-shot” production process, an oxygen gas target enriched with the isotope ¹⁸O₂ is first bombarded (shot) with a cyclotron produced 16.5 MeV proton beam of 40 μA for approximately 45 min. During this first shot, the protons from the cyclotron collide with the [¹⁸O]O₂ gas molecules, thereby causing a ¹⁸O(p,n)¹⁸F nuclear reaction that produces negatively charged ¹⁸F ions. These ¹⁸F⁽⁻⁾ ions adhere to the walls of the target and a second bombardment (shot) of protons is needed to “wash out” the radioactive fluorine. In this second shot, the [¹⁸O] isotope enriched oxygen gas in the target volume is removed by cryogenic cooling and replaced with a mixture of 0.1 to 2% F₂ (cold, i.e., non-radioactive, F₂) and argon (Ar), which is subsequently irradiated with another cyclotron produced 16.5 MeV proton beam of 35 μA for 20 minutes. The second bombardment of the Ar and cold F₂ succeeds in forcing a fluorine exchange that results in useful levels of [¹⁸F]F₂ in the gas phase.

Moreover, economic considerations also drive operators to efficiently use and conserve isotopically enriched [¹⁸O]oxygen gas, from which [¹⁸F]fluorine gas is synthesized. The enriched [¹⁸O]oxygen gas is expensive and must be handled with great care. It is also sold in rather small quantities and on usage it is important to be able to empty the whole enriched oxygen gas bottle into an appropriate reservoir of the [¹⁸F]F₂ production facility. Decreasing the oxygen reservoir volume improves the overall safety of the production facility and mitigates risk of loosing or contaminating large amounts of oxygen gas once it is in the system.

During the production of [¹⁸F]fluorine gas as noted above, there is a risk of filling the reservoir with too much or too little [¹⁸O]oxygen gas. Too much [¹⁸O]oxygen gas is wasteful and could potentially damage the reservoir as well as other components within the [¹⁸F]fluorine production system. Too little [¹⁸]oxygen gas will not enable the reservoir to provide enough [¹⁸O]oxygen to produce a useful amount of [¹⁸F]F₂. The development of a more reliable and safe technique for repeatedly delivering a precise amount of [¹⁸O]oxygen to the reservoir would be greatly beneficial.

### SUMMARY OF THE INVENTION

The present invention overcomes these and other deficiencies of the prior art by providing an intermediate container in the [¹⁸O]oxygen refilling system having a volume defined by the liquid equivalent of a predefined volume, pressure, and temperature of [¹⁸O]oxygen gas.

In at least one embodiment of the invention, a refilling apparatus comprises a first fluid container, a second fluid container, and an interface for coupling the first and second fluid containers to a supply of gas, wherein the first fluid container has a volume corresponding to a certain amount of liquid condensed from the gas, which upon phase transformation provides a desired gas pressure within an entire volume of the first and second fluid containers. The first fluid container is preferably a coil of tubing for submersion into a bath of liquid nitrogen to cryogenically cool the first fluid container, thereby condensing the gas into liquid form. A motor can be included to move the coil of tubing in and out the bath of liquid nitrogen at appropriate times. The apparatus is particularly well-suited for providing [¹⁸O]oxygen gas to a [¹⁸O]O₂/F₂ target system. The desired pressure is ideally based upon the apparatus supplying the [¹⁸O]O₂/F₂ target system with an appropriate amount of [¹⁸O]oxygen gas for a predetermined number of production runs. The desired gas pressure resulting from operation of the apparatus is preferably between 40 to 50 bar.

In at least one embodiment of the invention, a method comprises the steps of cryogenically cooling a first fluid container and supplying a gas to the cryogenically cooled first fluid container, wherein the gas condenses into liquid form within the cryogenically cooled first fluid container. Upon the first fluid container becoming full of the condensed liquid, the method further includes the steps of warming the first fluid container to transform the condensed liquid into gas, and allowing the transformed gas to expand into a second fluid container. The resulting transformed gas has a desired gas pressure within a total volume of the first and second fluid containers based upon the full volume of the condensed liquid in the first fluid container. The first fluid container is preferably a coil of tubing for submersion into a bath of liquid nitrogen to cryogenically cool the tubing and condense the gas into liquid form. To transform the liquid back into gas, the applied bath of liquid nitrogen is removed from the first fluid container. The process is ideally suited for [¹⁸O]oxygen gas for use in a [¹⁸O]O₂/F₂ target system that produces [¹⁸F]fluorine gas.

One advantage of the exemplary embodiments of the present invention is that it provides a reliable and safe technique for repeatedly delivering a precise amount of [¹⁸O]oxygen to a gas reservoir within a refilling system.

Another advantage of the exemplary embodiments of the present invention is that it mitigates, if not eliminates, the risk of over filling a reservoir with too much [¹⁸O]oxygen. Moreover, exemplary embodiments of the invention can maintain the highest possible gas purity since no equipment (e.g. vacuum pump) interferes with the gas during the refilling process.

The foregoing, and other features and advantages, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a two-shot [¹⁸O]O₂/F₂ target system according to at least one embodiment of the invention;

FIG. 2 illustrates an [¹⁸O]oxygen refilling apparatus according to at least one embodiment of the invention; and

FIG. 3 illustrates a process for operating the [¹⁸O]oxygen refilling apparatus of FIG. 2.

### DETAILED DESCRIPTION OF PREFERRED EMBODIMENTS

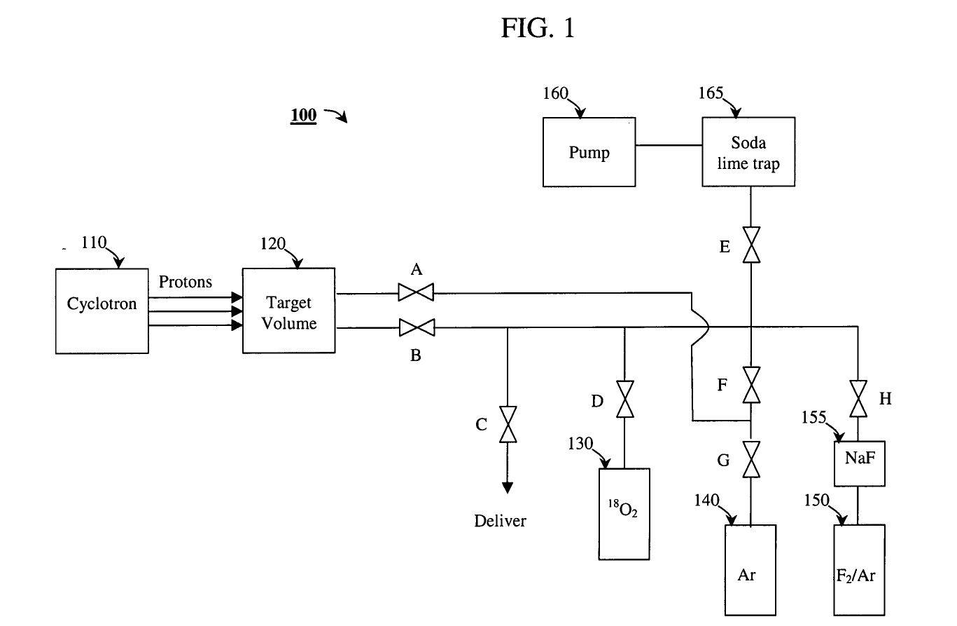

Preferred embodiments of the invention and their advantages may be understood by referring to FIGS. 1-3, wherein like reference numerals refer to like elements, and are described in the context of an [¹⁸O]oxygen refilling apparatus for a two-shot [¹⁸O]O₂/F₂ target system. Nonetheless, the present invention is applicable to any type of refilling system (and any gas) and the like that benefits from delivering a well defined gas volume from a larger gas volume with high pressure into a smaller volume by cryogenic cooling.

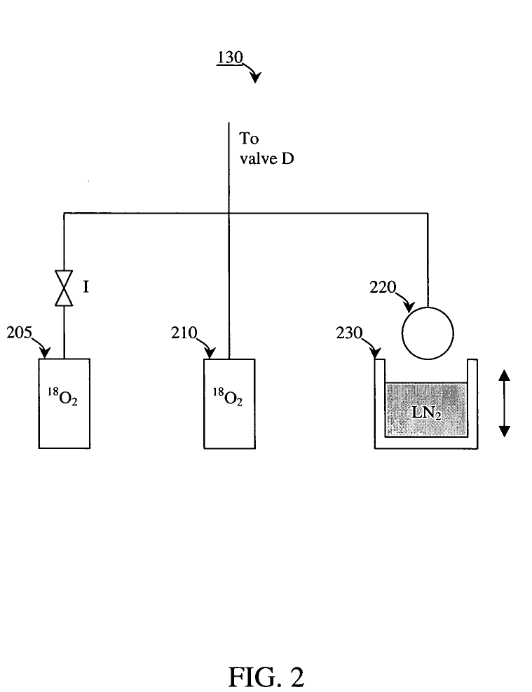

Referring to FIG. 1, a two-shot [¹⁸O]O₂/F₂ target system 100 is illustrated according to at least one embodiment of the invention. The system 100 includes a cyclotron 110, a target volume 120, an [¹⁸O]oxygen refilling apparatus 130, an argon reservoir 140, a Ar/F₂ reservoir 150, a pump 160, and valves A-I (valve I is shown in FIG. 2). In two-shot operation, the target volume 120 is first evacuated by and then isolated from the pump 160 by closing valve E. The target volume 120 is filled with [¹⁸O]oxygen from refilling apparatus 130 and valve B is closed. According to one embodiment, the cyclotron 110, the implementation of which is apparent to one of ordinary skill in the art, produces and directs a beam of 15.5 MeV protons (e.g., at b 40 μA for approximately 45 minutes) toward the [¹⁸O]oxygen within the target volume 120 to cause an ¹⁸O(p,n)¹⁸F nuclear reaction that produces ¹⁸F⁽⁻⁾ ions, which adhere to the walls of the target volume 120. After 45 minutes, proton production ceases and the unused [¹⁸O]oxygen remaining in the target volume 120 is cryopumped back into the oxygen refilling apparatus 130 by cooling it in a liquid nitrogen bath and opening valve B. The target volume 120 is refilled with an appropriate wash out mixture of argon from reservoir 140 and F₂/Ar from reservoir 150. The cyclotron 110 then irradiates for a second time the target volume 120 with a beam of protons at 16.5 MeV and 35 μA for 20 minutes, which forces a fluorine exchange that results in useful levels of [¹⁸F]F₂ in the gas phase, which is eventually released from the target volume 120 through valves B and C.

Parameters relevant to the design of the target volume 120 for fluorine isotope production are the beam strike volume, geometry, and material. Although not the focus of the present invention, it is worthy to note that different target volumes can be implemented as target volume 130 and variations in design of the target volume 120 can influence the amount of overall [¹⁸F]F₂ recovered in system 100. Target volumes for the ¹⁸O(p,n)¹⁸F reaction can be implemented using conical or straight bore shapes, beam entrance diameters of 10-15 mm, beam exit diameters of 10-23 mm, and volumes of 7.9-14.6 cc. Target volume 120 can be constructed from materials such as, but not limited to aluminum, silver, copper, nickel, or gold plated copper.

The washout mixture is provided by the argon reservoir 140 and the Ar/F₂ reservoir 150. These reservoirs 140 and 150 can each be implemented as a replaceable tank or a refillable reservoir having an input (not shown) for coupling the reservoir to an external supply of gas. Although argon is preferable, other noble gases can be used such as krypton (Kr) or neon (Ne). The Ar/F₂ reservoir 150 can be optionally coupled to an activated sodium-fluorine (NaF) trap 155 to remove any possible hydrogen fluoride contamination from the reservoir 150.

The pump 160 can be any type of conventional vacuum pump, the identification and implementation of which is apparent to one of ordinary skill in the art. An optional soda lime trap 165 can be coupled to the pump 160 to prevent harmful F₂ from contaminating the vacuum pump oil and escaping through the vacuum exhaust.

Valves A-I can each include a solenoid remotely controlled by CPU and/or a manual valve. These valves A-I open and close at varying times to allow the appropriate pressurized gases to flow to and from the various components among the system 100 as described herein. The components in system 100 (excluding cyclotron 110) are coupled to one another by way of appropriate conduits, e.g., pipes and/or tubing, the identification and implementation of which are apparent to one of ordinary skill in the art, in order to transport the various gases. One of ordinary skill in the art recognizes that other components such as pressure monitors can be coupled to the system 100 as deemed necessary.

Referring to FIG. 2, the [¹⁸O]oxygen refilling apparatus 130 is illustrated according to at least one embodiment of the invention. The [¹⁸O]oxygen refilling apparatus 130 comprises an [¹⁸O]oxygen reservoir 210, an intermediate container 220, and a liquid nitrogen dewar 230. An external and detachable [¹⁸O]oxygen bottle 205 is coupled to the refilling apparatus 130 as shown in the figure during refilling. A pressure transducer (not shown) can also be coupled to the refilling apparatus 130 to monitor pressure. The [¹⁸O]oxygen bottle 205 is implemented as a replaceable tank or bottle that is coupled to valve I. The reservoir 210 should maintain sufficient pressure to be able to fill the target volume 120 to a predefined pressure, e.g., 10 bar (other pressures can be used depending on proton beam energy, target size, etc.). In an exemplary embodiment, the reservoir 210 has a volume of 60 ml and requires a minimum pressure of 27 bar to be able to fill the target volume to 10 bar for a suitable number of production runs without having to refill the reservoir. The intermediate container 220 has a volume of approximately 3.3 ml (3.3 ml equals the volume that is cooled, the total volume of intermediate container 220 may be more as in one exemplary embodiment, the intermediate container 220 comprises a coiled loop and a long “neck” so that the coiled loop portion can be lowered into LN₂) and the overall volume of refilling system is approximately 60 ml (not including [¹⁸O]oxygen bottle 205). In this exemplary embodiment, ten production runs can be accomplished before having to refill the reservoir 210 from the [¹⁸O]oxygen bottle 205.

The intermediate container 220 is provided to ensure that a predefined volume of [¹⁸O]oxygen gas is filled into the refilling apparatus 130. Particularly, the intermediate container 220 has a volume selected so that when it is full of [¹⁸O]oxygen in liquid form, that liquid when changed to gas equals the necessary amount and pressure of [¹⁸O]oxygen gas to fill the oxygen refilling apparatus 130 with sufficient gas (but not overloading the system) to last for a selected number of [¹⁸F]fluorine production runs at ambient temperature. In other words, the volume of the intermediate container 220 is based on the desired [¹⁸O]oxygen gas volume and pressure, but in liquid phase. The liquid nitrogen dewar 230 is used to cool the intermediate container 220 to 77°K. so that the [¹⁸O]oxygen gas condenses into a liquid. The liquid nitrogen dewar 230 is preferably coupled to a motor that enables the dewar 230 to place a bath of liquid nitrogen in and out of contact with the intermediate container 220. The intermediate container 220 is preferably shaped as coiled tubing in order to maximize the surface area in contact with the liquid nitrogen, thereby expediting the cooling process. However, geometries other than coiled tubing such as, but not limited to a cylinder can be implemented. The intermediate container 220 can be designed to last for hundreds of productions runs and to provide the operator with a safe, repeatable, and reliable process.

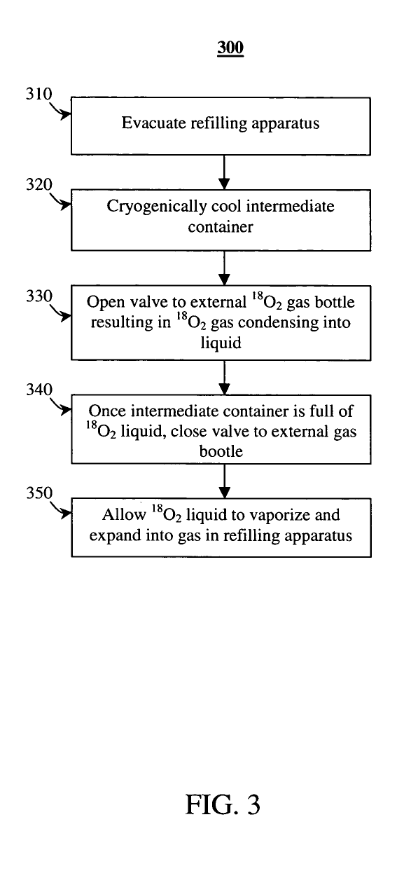

Referring to FIG. 3, a process 300 for operating the [¹⁸O]oxygen refilling apparatus 130 is illustrated according to at least one embodiment of the invention. Particularly, the refilling apparatus 130 is evacuated (step 310) and then valve D is closed. The intermediate container 220 is cryogenically cooled (step 320) by liquid nitrogen (LN₂) in dewar 230 and valve I is opened (step 330) to the [¹⁸O]oxygen bottle 205. The [¹⁸O]oxygen gas is condensed into liquid form within the intermediate container 220. When the intermediate container 220 is full with liquid [¹⁸O]oxygen (the pressure stabilizes and equals the set pressure, e.g., 1 bar, of the [¹⁸O]oxygen bottle 205), valve I is shut (step 340) and the liquid nitrogen is taken away (e.g., lowered) from intermediate container 220. As the intermediate container 220 warms to room temperature again, the liquid [¹⁸O]oxygen vaporizes into gas and is allowed to expand (step 350) in reservoir 210 and intermediate container 220, thereby resulting in an exact amount of [¹⁸O]oxygen gas with a predetermined pressure (e.g., approximately 44 bar from 3.3 ml liquid [¹⁸O]₂ expanded in a volume of approximately 60 ml=50 ml from reservoir+3.3 ml loop+6.7 ml of tubing, connections, etc.).

Valve I is placed near the [¹⁸O]oxygen bottle 205, from which a selected amount of gas (determined by the volume of intermediate container 220) will be cryocooled. It is preferred not to have any valve between reservoir 210 and intermediate container 220 since when the gas expands, there should be a volume for it to expand in. Otherwise, the intermediate container 220 and possibly the two-shot [¹⁸O]O₂/F₂ target system 100 may be put under a very large pressure and the tubes, connections, and valves could break.

The parameter values attributed to the proton beams, e.g., energy, current, and time, as well as the values attributed to the volume and pressures of the various gases and containers are exemplary only. One of ordinary skill in the art recognizes that these parameters can vary as deemed necessary or desired.

Although the invention has been particularly shown and described with reference to several preferred embodiments thereof, it will be understood by those skilled in the art that various changes in form and details may be made therein without departing from the spirit and scope of the invention as defined in the appended claims.

1. An apparatus comprising:
a first fluid container,
a second fluid container, and
an interface for coupling said first and second fluid containers to a supply of gas,
wherein said first fluid container has a volume corresponding to a certain amount of liquid condensed from said gas, which upon phase transformation provides a desired gas pressure within a total volume of said first and second fluid containers.

2. The apparatus of claim 1, wherein said first fluid container is a coil of tubing.

3. The apparatus of claim 1, further comprising a bath of liquid nitrogen for receiving the first fluid container.

4. The apparatus of claim 3, further comprising a motor for placing said first fluid container in and out of contact with said bath of liquid nitrogen.

5. The apparatus of claim 1, wherein said gas is [¹⁸O]oxygen gas.

6. (canceled)

7. (canceled)

8. The apparatus of claim 1, wherein a volume of said first fluid container is smaller than a volume of said second fluid container.

9. The apparatus of claim 1, wherein said interface includes a valve.

10. The apparatus of claim 1, wherein said desired gas pressure is 40 to 50 bar.

11. A method comprising the steps of:
cryogenically cooling a first fluid container,
supplying a gas to said cryogenically cooled first fluid container, wherein said gas condenses into liquid form within said cryogenically cooled first fluid container,
upon said first fluid container becoming full of said condensed liquid,
warming said first fluid container to transform said condensed liquid into gas, and
allowing said transformed gas to expand into a second fluid container,
wherein said transformed gas has a desired gas pressure within a total volume of
said first and second fluid containers based upon the full volume of said condensed liquid in said first fluid container.

12. The method of claim 11, wherein said first fluid container is a coil of tubing.

13. The method of claim 11, wherein said step of cryogenically cooling comprises the step of applying a bath of liquid nitrogen to said first fluid container.

14. The method of claim 13, wherein said step of warming comprises the step of removing said applied bath of liquid nitrogen from said first fluid container.

15. The method of claim 11, wherein said gas is [¹⁸O]oxygen.

16. The method of claim 11, further comprising the step of stopping said supply of gas upon said first fluid container becoming full of said condensed liquid.

17. The method of claim 11, wherein a volume of said first fluid container is smaller than a volume of said second fluid container.

18. The method of claim 11, further comprising the step of evacuating said first and second fluid containers prior to said step of cryogenically cooling said first fluid container.

19. The method of claim 11, further comprising the steps of:
coupling said first and second fluid containers to a [¹⁸O]O₂/F₂ target system, and allowing said transformed gas to flow from said first and second fluid containers to said [¹⁸O]O₂/F₂ target system.

20. The method of claim 11, wherein said desired gas pressure is 40 to 50 bar.

21. A system for the production of [¹⁸F]fluorine, comprising:
a target volume;
an [¹⁸O]oxygen refilling apparatus coupled to the target volume;
a wash out gas mixture apparatus coupled to the target volume; and
a cyclotron that produces and directs a beam of protons toward the target volume;
wherein the [¹⁸O]oxygen refilling apparatus comprises:
a first fluid container,
a second fluid container, and
an interface for coupling said first and second fluid containers to a supply of gas,
wherein said first fluid container has a volume corresponding to a certain amount of liquid condensed from said gas, which upon phase transformation provides a desired gas pressure within a total volume of said first and second fluid containers.

22. The [¹⁸F]fluorine production system of claim 21, wherein the wash out gas mixture apparatus comprises:
a first gas reservoir coupled to the target volume and the [¹⁸O]oxygen refilling apparatus; and
a second gas reservoir coupled to the target volume.

23. The [¹⁸F]fluorine production system of claim 22, wherein the first gas reservoir contains fluorine, and the second gas reservoir contains at least one of argon, krypton, and neon.

24. The [¹⁸F]fluorine production system of claim 21, further comprising:
a pump coupled to the target volume, the [¹⁸O]oxygen refilling apparatus, and the wash out gas mixture apparatus; and
a soda lime trap coupled to the pump.
